(19) United States
(12) Patent Application Publication
(10) Pub. No.: US 2013/0307201 A1
(43) Pub. Date: Nov. 21, 2013

(54) CERAMIC ARTICLE AND ADDITIVE PROCESSING METHOD THEREFOR

(71) Applicant: Bryan William McEnerney, Canoga Park, CA (US)

(72) Inventor: Bryan William McEnerney, Canoga Park, CA (US)

(21) Appl. No.: 13/475,275

(22) Filed: May 18, 2012

(51) Int. Cl. C04B 35/64; C04B 35/03; C04B 35/10; C04B 35/50; C04B 35/00; C04B 35/46

(52) U.S. Cl. 264/642; 501/1; 501/134; 501/153

(57) ABSTRACT

An additive manufacturing process includes providing a powder mixture having a ceramic constituent and a reactive metal constituent, and reacting and fusing the powder mixture with a directed energy source to form a geometry.

### BACKGROUND

This disclosure relates to improvements in forming ceramic articles.

Ceramic components are known and used in relatively high temperature environments. One common technique of forming a ceramic component is powder processing, such as slip casting. A typical powder processing technique involves a mixture of a ceramic powder, processing aids and organic or water-based binders/carriers that facilitate forming a green ceramic body. Typically, the green ceramic body is slowly heated to carefully remove the binder/carrier without disturbing the fragile structure. The green ceramic body is then heated according to a prescribed temperature profile to carefully sinter the ceramic powder to a final or near final geometry without generating thermal stresses and cracking that can otherwise ruin the component.

### SUMMARY

An additive manufacturing process according to one exemplary aspect of the present disclosure includes providing a powder mixture having a ceramic constituent and a reactive metal constituent, and reacting and fusing the powder mixture with a directed energy source, thereby forming a geometry.

In a further non-limiting embodiment of any of the foregoing example, the providing of the powder mixture includes depositing multiple layers of the powder mixture onto one another, and the reacting and fusing is conducted with reference to data relating to a particular cross-section of the geometry.

In a further non-limiting embodiment of any of the foregoing examples, the ceramic constituent is selected from the group consisting of alumina, titania, yttria-stabilized zirconia, magnesia and combinations thereof, and the metallic phase selected from the group consisting of aluminum, magnesium, titanium and combinations thereof.

In a further non-limiting embodiment of any of the foregoing examples, the ceramic constituent includes alumina and magnesia and the metallic phase includes aluminum.

In a further non-limiting embodiment of any of the foregoing examples, the powder mixture includes greater than 10 percent by weight of the metal constituent.

In a further non-limiting embodiment of any of the foregoing examples, the powder mixture consists of the ceramic constituent and the metal constituent, the ceramic constituent consisting of alumina and magnesia and the metal constituent consisting of aluminum.

In a further non-limiting embodiment of any of the foregoing examples, the reacting and fusing is conducted in an oxygen-containing environment.

In a further non-limiting embodiment of any of the foregoing examples, the reacting and fusing is conducted in an air environment.

In a further non-limiting embodiment of any of the foregoing examples, the reacting and fusing is conducted in the presence of oxygen such that the metal constituent reacts to form an oxide.

In a further non-limiting embodiment of any of the foregoing examples, the reacting and fusing is conducted at ambient pressure.

In a further non-limiting embodiment of any of the foregoing examples, the ceramic constituent and the oxide formed from the metal constituent are equivalent oxides with regard to composition.

An additive manufacturing process according to one exemplary aspect of the present disclosure includes providing a powder mixture including a first powder consisting of one or more oxide ceramic constituents and a second powder consisting of one or more metal constituents, fusing the powder mixture to form a geometry with reference to data relating to a particular cross-section of an article, the fusing including using a directed energy source to cause melting of the one or more metal constituents such that the one or more melted metal constituents then solidify to hold the first powder together, and treating the geometry to convert the one or more metal constituents to one or more metal oxides.

In a further non-limiting embodiment of any of the foregoing examples, the one or more oxide ceramic constituents are selected from the group consisting of alumina, titania, yttria-stabilized zirconia, magnesia and combinations thereof, and the one or more metals are selected from the group consisting of aluminum, magnesium, titanium and combinations thereof.

In a further non-limiting embodiment of any of the foregoing examples, the one or more oxide ceramic constituents include alumina and magnesia, and the one or more metal constituents include aluminum.

In a further non-limiting embodiment of any of the foregoing examples, the powder mixture includes greater than 10 percent by weight of the aluminum.

In a further non-limiting embodiment of any of the foregoing examples, the powder mixture consists of the first powder and the second powder, the one or more oxide ceramic constituents consisting of alumina and magnesia and the one or more metal constituents consisting of aluminum.

A work piece ready for processing to form a ceramic article, according to an exemplary aspect of the present disclosure, includes a structure having a geometry corresponding to a geometry defined by a computer-aided design, the structure including one or more metals and particles having one or more ceramic phases, the particles being held together exclusively by the one or more metals.

In a further non-limiting embodiment of any of the foregoing examples, the one or more ceramic phases are selected from the group consisting of alumina, titania, yttria-stabilized zirconia, magnesia and combinations thereof, and the one or more metals are selected from the group consisting of aluminum, magnesium, titanium and combinations thereof.

In a further non-limiting embodiment of any of the foregoing examples, the one or more ceramic phases include alumina and magnesia, and the one or more metals include aluminum.

In a further non-limiting embodiment of any of the foregoing examples, the structure includes greater than 10 percent by weight of the one or more metals.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 shows an example additive manufacturing process.

FIG. 2 shows another aspect of an additive manufacturing process.

FIG. 3 depicts different stages through an additive manufacturing process.

### DETAILED DESCRIPTION

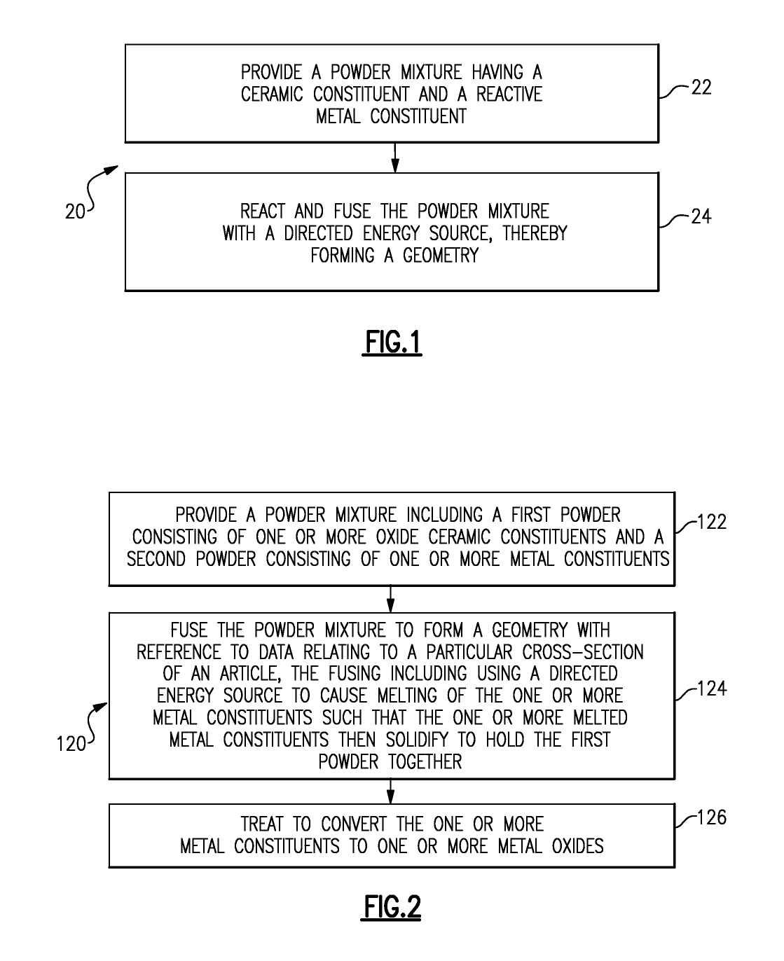

FIG. 1 illustrates selected portions of an example additive manufacturing process 20 (hereafter process 20) for making a ceramic article. As will be appreciated from the following description, the process 20 can be used to form a variety of different kinds of ceramic articles, such as, but not limited to ceramic mold cores for investment casting. Moreover, the process 20 can also provide rapid manufacturing and thus may also be used in the rapid prototyping of ceramic articles.

As shown, the process 20 generally includes steps 22 and 24. Step 22 includes providing a powder mixture having a ceramic constituent and a reactive metal constituent and step 24 includes reacting and fusing the powder mixture with a directed energy source to thereby form a geometry. For example, the ceramic constituent is a ceramic phase and the metal constituent is a metallic phase that can include one or more metals.

In a further example, the step 22 can include depositing multiple layers of the powder mixture onto one another. As an example, the layers are deposited using deposition techniques known in rapid prototyping or additive manufacturing.

The powder mixture includes the ceramic constituent and the reactive metal constituent, which will later serve to hold the powder mixture together. For example, the ceramic constituent and the reactive metal constituent can be provided as separate homogenous powders that are mixed together to form the powder mixture, or alternatively as heterogeneous particles.

The step 24 includes fusing the powder mixture together. For example, the layers are fused to one another to form the geometry with reference to data relating to a particular cross-section of an article. In a further example, the data is computer-aided design data that defines the geometry of the article to be produced. The fusing includes using a directed energy source to cause melting of the reactive metal constituent. In one example, the directed energy source is a laser. Thus, the laser heats the reactive metal constituent to a temperature above its melting temperature. The melted reactive metal constituent flows and subsequently solidifies to hold the remaining powder mixture together.

The step 24 also includes reacting the reactive metal constituent. The reacting of the reactive metal constituent can occur in overlap with the fusing. That is, when the metal constituent melts, at least a portion of the metal constituent can react before or during solidifying. In other additive manufacturing processes, there is a desire to avoid reactions and thus an inert process environment is used. In the process 20, however, the reactions are promoted by use of a reactive process environment with regard to the reactive metal constituent. Alternatively, a portion, or substantially all, of the reactive metal constituent can react after solidifying. For example, after melting and solidifying, the directed energy source can be used to heat the solidified metal constituent to a reaction temperature to react the metal constituent. The reaction temperature may depend upon the selected metal constituent. In one example, the temperature is 700-800° C.

In a further example, the process environment in which the reactive metal constituent is reacted includes oxygen in greater than impurity amounts of fractions of a volume percent. Thus, the reactive metal constituent is heated and reacts with oxygen from the process environment to form an oxide. In one example, the step 24 is conducted in an air environment at ambient pressure. Alternatively, the step 24 is conducted in a different reactive process environment that includes other active elements for converting the metal constituent to another type of non-oxide or non-oxide/oxide ceramic.

The compositions of the ceramic constituent and the metal constituent are selected depending upon the desired final composition of the article being produced. For example, the ceramic constituent is selected from alumina (Al₂O₃), titania (TiO₂), yttria-stabilized zirconia, magnesia (MgO) and combinations thereof, and the metal constituent is selected from aluminum, magnesium, titanium and combinations thereof. In embodiments, the exemplary compositions are useful for forming investment molding cores, for example. In the step 24, for an oxygen process environment, aluminum converts to alumina, magnesium converts to magnesia and/or titanium converts to titania.

In a further example, the ceramic constituent includes alumina and magnesia and the metal constituent includes aluminum.

In a further example, the ceramic constituent includes only one or more of alumina, titania, yttria-stabilized zirconia and magnesia, along with any incidental impurities, and the metal constituent includes only one or more of aluminum, magnesium and titanium, along with any incidental impurities.

In a further example based on any of the prior examples, the metal constituent is selected such that upon reaction in the step 24, the oxide formed from the metal constituent has an equivalent composition to the ceramic constituent of the powder mixture.

In a further example based on any of the prior examples, the metal constituent is present in the powder mixture in an amount greater than 10% by weight in order to effectively bind the ceramic constituent together.

In another aspect, FIG. 2 schematically illustrates selected portions of an additive manufacturing process 120 (hereafter process 120). In this example, the process 120 includes a step 122, a fusing step 124 and a treatment step 126. Turning first to the step 122, a powder mixture is provided. The powder mixture includes a first powder of only one or more oxide ceramic constituents and a second powder of only one or more metal constituents. The powder mixture may be provided in a ready-mixed form or can be mixed from initially separate powders.

The fusing step 124 and the treatment step 126 can be conducted in using the directed energy source, as described above with regard to the step 24 with the exception that the treatment step 126 is specifically directed to converting the one or more metal constituents of the powder mixture to one or more metal oxides.

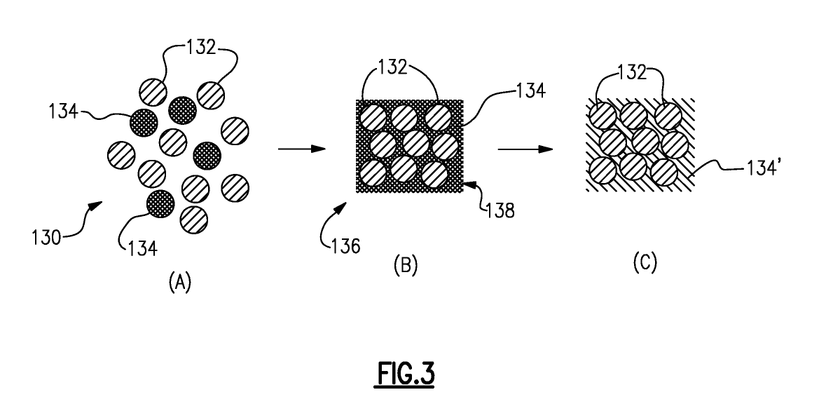

FIG. 3 schematically depicts the process 120 through stages (A), (B) and (C), which correspond to the respective steps 122, 124 and 126 described above. As shown at stage (A), a powder mixture 130 includes particles 132 of the first powder and particles 134 of the second powder. At stage (B), the particles 134 of the one or more metal constituents are melted such that the one or more metal constituents solidify to hold the particles 132 of the first powder together. A work piece 136 is thus formed during stage (B). The work piece 136 includes a structure 138 that has a geometry that corresponds to a geometry defined by a computer-aided design. The structure 138 includes the one or more metals and the particles 132 of the first powder. The particles 132 are held together exclusively by the one or more metals. That is, the particles 132 are not bonded directly to each other and, but for the presence of the one or more metals, would not be supported in the desired shape of the structure 138. At stage (C), the structure has been treated according to the treatment step 126 to convert the one or more metals to one or more metal oxides 134′.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. An additive manufacturing process comprising:
providing a powder mixture having a ceramic constituent and a reactive metal constituent; and
reacting and fusing the powder mixture with a directed energy source, thereby forming a geometry.

2. The method as recited in claim 1, wherein the providing of the powder mixture includes depositing multiple layers of the powder mixture onto one another, and the reacting and fusing is conducted with reference to data relating to a particular cross-section of the geometry.

3. The method as recited in claim 1, wherein the ceramic constituent is selected from the group consisting of alumina, titania, yttria-stabilized zirconia, magnesia and combinations thereof, and the metallic phase selected from the group consisting of aluminum, magnesium, titanium and combinations thereof.

4. The method as recited in claim 1, wherein the ceramic constituent includes alumina and magnesia and the metallic phase includes aluminum.

5. The method as recited in claim 1, wherein the powder mixture includes greater than 10 percent by weight of the metal constituent.

6. The method as recited in claim 1, wherein the powder mixture consists of the ceramic constituent and the metal constituent, the ceramic constituent consisting of alumina and magnesia and the metal constituent consisting of aluminum.

7. The method as recited in claim 1, wherein the reacting and fusing is conducted in an oxygen-containing environment.

8. The method as recited in claim 1, wherein the reacting and fusing is conducted in an air environment.

9. The method as recited in claim 1, wherein the reacting and fusing is conducted in the presence of oxygen such that the metal constituent reacts to form an oxide.

10. The method as recited in claim 9, wherein the reacting and fusing is conducted at ambient pressure.

11. The method as recited in claim 9, wherein the ceramic constituent and the oxide formed from the metal constituent are equivalent oxides with regard to composition.

12. An additive manufacturing process comprising:
providing a powder mixture including a first powder consisting of one or more oxide ceramic constituents and a second powder consisting of one or more metal constituents;
fusing the powder mixture to form a geometry with reference to data relating to a particular cross-section of an article, the fusing including using a directed energy source to cause melting of the one or more metal constituents such that the one or more melted metal constituents then solidify to hold the first powder together; and
treating the geometry to convert the one or more metal constituents to one or more metal oxides.

13. The method as recited in claim 12, wherein the one or more oxide ceramic constituents are selected from the group consisting of alumina, titania, yttria-stabilized zirconia, magnesia and combinations thereof, and the one or more metals are selected from the group consisting of aluminum, magnesium, titanium and combinations thereof.

14. The method as recited in claim 12, wherein the one or more oxide ceramic constituents include alumina and magnesia, and the one or more metal constituents include aluminum.

15. The method as recited in claim 14, wherein the powder mixture includes greater than 10 percent by weight of the aluminum.

16. The method as recited in claim 12, wherein the powder mixture consists of the first powder and the second powder, the one or more oxide ceramic constituents consisting of alumina and magnesia and the one or more metal constituents consisting of aluminum.

17. A work piece ready for processing to form a ceramic article, comprising:
a structure having a geometry corresponding to a geometry defined by a computer-aided design, the structure including one or more metals and particles having one or more ceramic phases, the particles being held together exclusively by the one or more metals.

18. The work piece as recited in claim 17, wherein the one or more ceramic phases are selected from the group consisting of alumina, titania, yttria-stabilized zirconia, magnesia and combinations thereof, and the one or more metals are selected from the group consisting of aluminum, magnesium, titanium and combinations thereof.

19. The work piece as recited in claim 17, wherein the one or more ceramic phases include alumina and magnesia, and the one or more metals include aluminum.

20. The work piece as recited in claim 17, wherein the structure includes greater than 10 percent by weight of the one or more metals.
